(19) United States
(12) Patent Application Publication
(10) Pub. No.: US 2010/0085455 A1
(43) Pub. Date: Apr. 8, 2010

(54) IMAGING APPARATUS AND METHOD OF DRIVING SOLID-STATE IMAGING DEVICE

(75) Inventor: Takashi GOTO, Kanagawa (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/575,187

(22) Filed: Oct. 7, 2009

(30) Foreign Application Priority Data
Oct. 8, 2008 (JP) P2008-261679

(51) Int. Cl. H04N 5/335

(52) U.S. Cl. 348/296; 348/E05.091

(57) ABSTRACT

In an imaging apparatus having plural pixel units each including a photoelectric conversion portion, each pixel unit has a writing transistor WT and a reading transistor RT each including a floating gate FG disposed on a semiconductor substrate so as to accumulate electric charges generated in the photoelectric conversion portion, and the imaging apparatus includes a control unit independently performing a first charge discharging drive operation of discharging the electric charges generated in the photoelectric conversion portion of each pixel unit in a group to a writing drain WD or a reading drain RD in the pixel unit by groups including plural pixel units and controlling an exposure period start time of each group.

### CROSS-REFERENCE TO RELATED APPLICATIONS

This application claims the benefit of Japanese Patent Application No. 2008-261679, filed on Oct. 8, 2008, the entire contents of which are hereby incorporated by reference, the same as if set forth at length.

### BACKGROUND OF THE INVENTION

1. Technical Field

The present invention relates to an imaging apparatus having plural pixel units each including a photoelectric conversion portion.

2. Description of Related Art

A solid-state imaging apparatus which captures an image by injecting and accumulating electric charges, which generated in a photoelectric conversion element such as a photo diode (PD), into a floating gate (FG) serving as a charge accumulating portion by a MOS transistor having the FG and by reading out a signal corresponding to the electric charges accumulated in the FG was suggested.

In the apparatus described in JP 2002-280537 A, the apparatus operates as a so-called global shutter in which the exposure is simultaneously started in all the pixels. In the solid-state imaging device, all PDs are simultaneously emptied and thus the exposure of all the PDs is started, by applying a high voltage to a semiconductor substrate just before the start of the exposure period to discharge electric charges, which have been generated and accumulated in all the PDs before the start of the exposure period, to the semiconductor substrate.

This driving of the global shutter is suitable for a still image capture of acquiring still image data of one sheet such as a photograph. However, for example, in a moving image capture of fast and continuously acquiring still image data, such as a video image, since a frame period is (exposure period+reading period for reading signals corresponding to the electric charges accumulated in the FGs of all pixels), the time of one frame increases. As a result, the frame rate decreases and it is difficult continuously to take an image of a fast subject. In general, a video image is displayed in a line sequential manner. Accordingly, when the image is not taken in the line sequential manner by the image capture system, an unnatural video is displayed.

JP 2002-280537 A discloses only a driving method employing the global shutter driving operation suitable for a still image capturing mode and does not specifically disclose a driving method suitable for a moving image capturing mode.

### SUMMARY

Illustrative aspect of the invention is to provide an imaging apparatus and a method of driving a solid-state imaging device, which can allow taking a natural and smooth moving image.

An imaging apparatus includes pixel groups and an exposure start control unit. Each pixel group includes plural pixel units. Each pixel unit includes a photoelectric conversion portion and a transistor having a charge accumulating portion which is disposed above a semiconductor substrate and which accumulates electric charges generated in the photoelectric conversion portion. The exposure start control unit independently performs, for each pixel group, a first charge discharging drive operation of discharging the electric charges generated in the photoelectric conversion portions of the pixel units to drain regions of the transistors of the pixel units, to control an exposure period start timing of each pixel group.

With this configuration, the exposure period start times can be made to be different from each other by the groups including the plural pixel units. Accordingly, it is possible to perform a rolling shutter operation suitable for the moving image capture.

The imaging apparatus may further include a charge discharging unit. The charge discharging unit performs second charge discharging drive operation of (I) reading a signal corresponding to the electric charges generated in the photoelectric conversion portions of the pixel units of each pixel group during an exposure period of each pixel group and accumulated in the charge accumulating portion of each pixel unit, and (II) discharging the electric charges to the drain regions of the transistors of the pixel units of each pixel group. First timings of the respective pixel groups at which the charge discharging unit performs the second charge discharging drive operation for the pixel groups are different from each other.

With this configuration, since the electric charges in the charge accumulating portion can be erased at different times by the groups, it is possible to realize the rolling shutter operation suitable for the moving image capture.

The imaging apparatus may further include a simultaneous exposure start control unit and a simultaneous charge discharging unit. The simultaneous exposure start control unit simultaneously discharges the electric charges generated in the photoelectric conversion portions of the pixel units of all the pixel groups to the semiconductor substrate to match start timings of the exposure periods of all the pixel units with each other in a still image capturing mode. The simultaneous charge discharging unit simultaneously discharges the electric charges accumulated in the charge accumulating portions of the pixel units of all the pixel groups to the semiconductor substrate in the still image capturing mode. The exposure start control unit and the charge discharging unit operate only in a moving image capturing mode. The exposure start control unit performs the first charge discharging drive operation for the pixel groups. Second timings of the respective pixel groups at which the exposure start control unit performs the first charge discharging drive operation for the pixel groups are different from each other.

With this configuration, the so-called global shutter operation of simultaneously exposing all the pixel units can be realized in the still image capturing mode and the so-called rolling shutter operation in which the exposure periods are different by the groups can be realized in the moving image capturing mode. Accordingly, it is possible to allow a high-quality still image capture without any distortion to be consistent with a natural and smooth moving image capture.

In the imaging apparatus, the exposure start control unit simultaneously performs the first charge discharging drive operation for all the pixel groups in a still image capturing mode. Second timings of the respective pixel groups at which the exposure start control unit performs the first charge discharging drive operation for the pixel groups are different from each other in a moving image capturing mode. The charge discharging unit performs the second charge discharging drive operation in the still image capturing mode and the moving image capturing mode.

With this configuration, the so-called global shutter operation of simultaneously exposing all the pixel units can be realized in the still image capturing mode and the so-called rolling shutter operation in which the exposure periods are different by the groups can be realized in the moving image capturing mode. Accordingly, it is possible to allow a high-quality still image capture without any distortion to be consistent with a natural and smooth moving image capture. With this configuration, the potential variation of the semiconductor substrate does not occur in any of the still image capturing mode and the moving image capturing mode. Accordingly, it is possible to prevent the deterioration in the oxide film on the surface of the semiconductor substrate due to the potential variation or the increase in dark current in the vicinity of the source and drain junction of the transistor.

In the imaging apparatus, the transistor of each pixel unit is a writing transistor for injecting and accumulating the electric charges in the charge accumulating portion of each pixel unit. The first charge discharging drive operation is a drive operation of discharging the electric charges generated in the photoelectric conversion portions of each pixel group to the drain regions of the writing transistors of each pixel group through channel regions of the writing transistors of each pixel group by applying to gate electrodes of the writing transistors of each pixel group a second voltage lower than a first voltage to be applied to the gate electrodes of the writing transistors of each pixel group to inject the electric charges into the charge accumulating portions of each pixel group by means of the writing transistors of each pixel group.

In the imaging apparatus, each pixel unit further includes another transistor. The two transistors of each pixel unit include a writing transistor for injecting and accumulating the electric charges in the charge accumulating portion of each pixel unit and a reading transistor for reading a signal corresponding to the electric charges accumulated in the charge accumulating portion of each pixel unit. A floating gate of the writing transistor and a floating gate of the reading transistor are electrically connected to each other. The charge accumulating portion of each pixel unit includes the floating gates. The first charge discharging drive operation is a drive operation of injecting the electric charges generated in the photoelectric conversion portions of each pixel group into the floating gates of the writing transistors of each pixel group and discharging the electric charges injected into the floating gates of each pixel group to the drain regions of the reading transistors of each pixel group.

The imaging apparatus may further include a driving unit. The driving unit drives the writing transistor of each pixel unit to inject the electric charges, which are generated in the photoelectric conversion portion of each pixel unit during the exposure period, into the charge accumulating portion of each pixel unit during the exposure period.

According to this configuration, since the exposure period overlaps with the charge injection period in the charge accumulating portion, it is possible to reduce the image capture time.

The imaging apparatus may further include a driving unit. The driving unit drives the writing transistor to stop during the exposure period, injecting the electric charges, which are generated in the photoelectric conversion portions, into the charge accumulating portions, and drives the writing transistors to inject the electric charges, which are generated in the photoelectric conversion portions during the exposure period, into the charge accumulating portions after an end of the exposure period.

With this configuration, since the injection of the electric charges into the charge accumulating portion is stopped during the exposure period, it is possible to reduce the possibility that any noise can be mixed into the charge accumulating portion during the exposure period, thereby improving the image quality.

In this imaging apparatus, the writing transistors inject the electric charges using a hot electron injection method.

In this imaging apparatus, the writing transistors inject the electric charges using a tunnel electron injection method.

In this imaging apparatus, each photoelectric conversion portion includes a photoelectric conversion element disposed above the semiconductor substrate.

In this imaging apparatus, each photoelectric conversion element is formed of one of an amorphous silicon, a CIGS (Copper-Indium-gallium-selenium)-based material, and an organic material.

A method of driving a solid-state imaging device includes pixel groups. Each pixel group includes plural pixel units. Each pixel unit includes a photoelectric conversion portion, and a transistor having a charge accumulating portion which is disposed above a semiconductor substrate and which accumulates electric charges generated in the photoelectric conversion portion. The method includes an exposure start control step. The exposure start control step is independently performed, for each pixel group, a first charge discharging drive operation of discharging the electric charges generated in the photoelectric conversion portions of the pixel units to drain regions of the transistors of the pixel units, to control an exposure period start timing of each pixel group.

The method of driving the solid-state imaging device may further includes a charge discharging step. The charge discharging step is performed a second charge discharging drive operation of (I) reading a signal corresponding to the electric charges generated in the photoelectric conversion portions of the pixel units of each pixel group during an exposure period of each pixel group and accumulated in the charge accumulating portion of each pixel unit, and (II) discharging the electric charges to the drain regions of the transistors of the pixel units of each pixel group. First timings of the respective pixel groups at which the charge discharging step performs the second charge discharging drive operation for the pixel groups are different from each other.

The method of driving the solid-state imaging device may further includes a simultaneous exposure start control step and a simultaneous charge discharging step. The simultaneous exposure start control step is simultaneously discharged the electric charges generated in the photoelectric conversion portions of the pixel units of all the pixel groups to the semiconductor substrate to match start timings of the exposure periods of all the pixel units with each other in a still image capturing mode. The simultaneous charge discharging step is simultaneously discharged the electric charges accumulated in the charge accumulating portions of the pixel units of all the pixel groups to the semiconductor substrate in the still image capturing mode. The exposure start control step and the charge discharging step are performed only in a moving image capturing mode. The exposure start control step performs the first charge discharging drive operation for the pixel groups. Second timings of the respective pixel groups at which the exposure start control step performs the first charge discharging drive operation for the pixel groups are different from each other.

In the method of driving the solid-state imaging device, the exposure start control step simultaneously performs the first charge discharging drive operation for all the pixel groups in a still image capturing mode. Second timings of the respective pixel groups at which the exposure start control step performs the first charge discharging drive operation for the pixel groups are different from each other in a moving image capturing mode. The charge discharging step performs the second charge discharging drive operation in the still image capturing mode and the moving image capturing mode.

In the method of driving the solid-state imaging device, the transistor of each pixel unit is a writing transistor for injecting and accumulating the electric charges in the charge accumulating portion of each pixel unit. The first charge discharging drive operation is a drive operation of discharging the electric charges generated in the photoelectric conversion portions of each pixel group to the drain regions of the writing transistors of each pixel group through channel regions of the writing transistors of each pixel group by applying to gate electrodes of the writing transistors of each pixel group a second voltage lower than a first voltage to be applied to the gate electrodes of the writing transistors of each pixel group to inject the electric charges into the charge accumulating portions of each pixel group by means of the writing transistors of each pixel group.

In the method of driving the solid-state imaging device, each pixel unit further includes another transistor. The two transistors of each pixel unit include a writing transistor for injecting and accumulating the electric charges in the charge accumulating portion of each pixel unit and a reading transistor for reading a signal corresponding to the electric charges accumulated in the charge accumulating portion of each pixel unit. A floating gate of the writing transistor and a floating gate of the reading transistor are electrically connected to each other. The charge accumulating portion of each pixel unit includes the floating gates. The first charge discharging drive operation is a drive operation of injecting the electric charges generated in the photoelectric conversion portions of each pixel group into the floating gates of the writing transistors of each pixel group and discharging the electric charges injected into the floating gates of each pixel group to the drain regions of the reading transistors of each pixel group.

The method of driving the solid-state imaging device may further includes a driving step. The driving step is driven the writing transistors to stop, during the exposure period, injection the electric charges, which are generated in the photoelectric conversion portions, into the charge accumulating portions, and driving the writing transistors to inject the electric charges, which are generated in the photoelectric conversion portions during the exposure period, into the charge accumulating portions after an end of the exposure period.

The method of driving the solid-state imaging device may further includes a driving step. The driving step is driven the writing transistor of each pixel unit to inject the electric charges, which are generated in the photoelectric conversion portion of each pixel unit during the exposure period, into the charge accumulating portion of each pixel unit during the exposure period.

In the method of driving the solid-state imaging device, the writing transistors are driven so as to inject the electric charges using a hot electron injection method.

In the method of driving the solid-state imaging device, the writing transistors are driven so as to inject the electric charges using a tunnel electron injection method.

In the method of driving the solid-state imaging device, each photoelectric conversion portion includes a photoelectric conversion element disposed above the semiconductor substrate.

In the method of driving the solid-state imaging device, each photoelectric conversion element is formed of one of an amorphous silicon, a CIGS (Copper-Indium-gallium-selenium)-based material, and an organic material.

According to the above-mentioned invention, it is possible to provide an imaging apparatus and a method of driving a solid-state imaging device, which can allow taking a natural and smooth moving image.

### BRIEF DESCRIPTION OF THE DRAWINGS

FIG. 1A is a plan view schematically illustrating the configuration of a solid-state imaging device according to an embodiment of the invention.

FIG. 1B is a view schematically illustrating the configuration of a reading circuit 20 shown in FIG. 1A.

FIG. 2 is a sectional view schematically illustrating the configuration of a pixel unit shown in FIG. 1A.

FIG. 3 is an equivalent circuit diagram of the pixel unit shown in FIG. 1A.

FIG. 4 is a timing diagram illustrating a driving method in a still image capturing mode in the solid-state imaging device shown in FIG. 1A.

FIG. 5 is a timing diagram illustrating a driving method in a moving image capturing mode in the solid-state imaging device shown in FIG. 1A.

FIG. 6 is a timing diagram illustrating a modified example of the driving method shown in FIG. 4.

FIG. 7 is a timing diagram illustrating a modified example of the driving method shown in FIG. 4.

FIG. 8 is a timing diagram illustrating a modified example of the driving method shown in FIG. 5.

FIG. 9 is a timing diagram illustrating a modified example of the driving method shown in FIG. 6.

FIG. 10 is a sectional view schematically illustrating another configuration of a pixel unit of the solid-state imaging device shown in FIG. 1A.

### DETAILED DESCRIPTION OF EMBODIMENTS OF THE INVENTION

Hereinafter, a solid-state imaging device according to an embodiment of the invention will be described with reference to the accompanying drawings. The solid-state imaging device is mounted on an imaging apparatus such as a digital camera or a digital video camera.

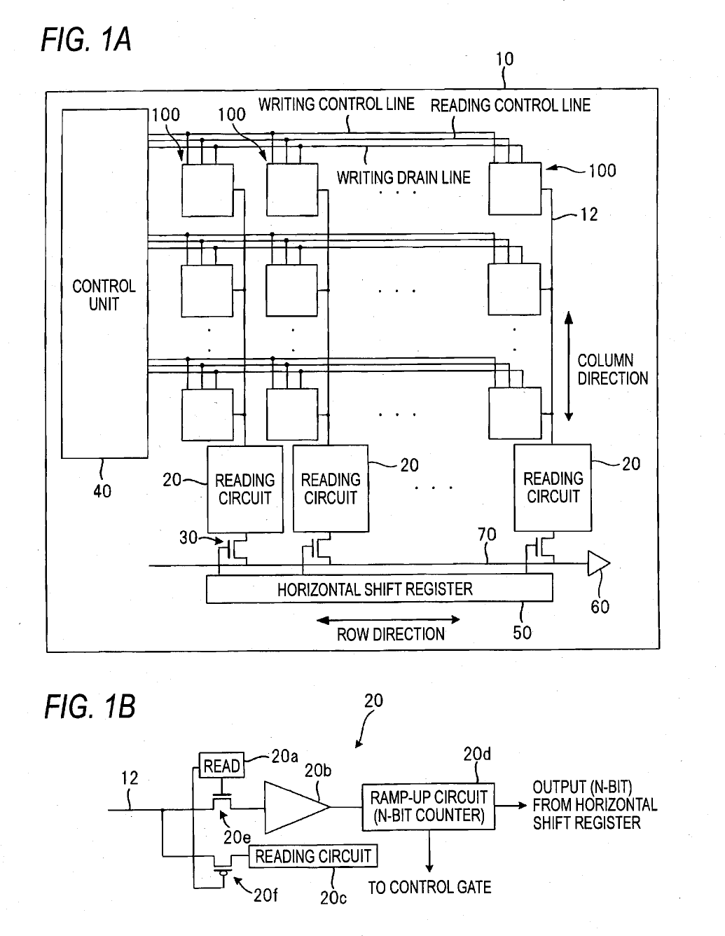

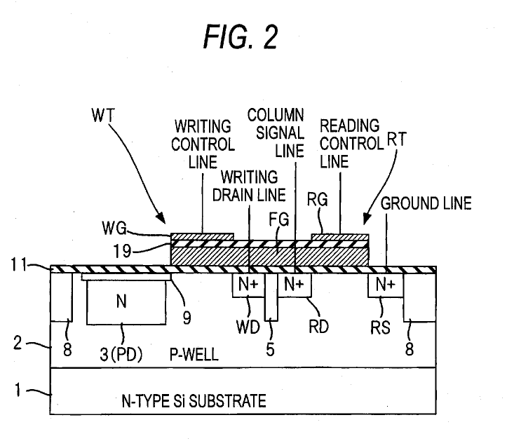

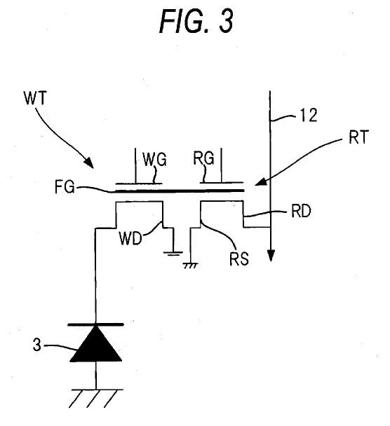

FIG. 1A is a plan view schematically illustrating the configuration of a solid-state imaging device according to an embodiment of the invention. FIG. 2 is a sectional view schematically illustrating the configuration of a pixel unit shown in FIG. 1A. FIG. 3 is an equivalent circuit diagram of the pixel unit shown in FIG. 2.

The solid-state imaging device 10 includes plural pixel units 100 arranged in an array (herein, in a square lattice shape) in a row direction and a column direction perpendicular thereto in the same plane.

Each pixel unit 100 has an N-type impurity layer 3 formed in a semiconductor substrate including an N-type silicon substrate 1 and a P-well layer 2 formed thereon. The N-type impurity layer 3 is formed in the P-well layer 2 and a photo diode (PD) serving as a photoelectric conversion portion is formed by the PN junction of the N-type impurity layer 3 and the P-well layer 2. Hereinafter, the N-type impurity layer 3 is called photoelectric conversion portion 3. The photoelectric conversion portion 3 is a so-called embedded photo diode in which a P-type impurity layer 9 for complete depletion or suppression of dark current is formed on the surface thereof.

A reading portion capable of reading out a voltage signal (hereinafter, also referred to as “image capturing signal”) corresponding to the charges generated in the photoelectric conversion portion 3 is formed in the semiconductor substrate.

The reading portion includes a writing transistor WT and a reading transistor RT. The writing transistor WT and the reading transistor RT are separated from each other by an element separating region 5 disposed slightly apart to the right from the photoelectric conversion portion 3. The elements of the pixel units 100 in the P-well layer 2 are separated from each other by the element separating region 8.

As an element separating method, a LOCOS (Local Oxidation of Silicon) method, an STI (Shallow Trench Isolation) method, a high-concentration impurity ion implanting method, and the like can be employed.

The writing transistor WT has an MOS transistor structure having a photoelectric conversion portion 3 serving as a source region, a writing drain WD which is a drain region formed of a high-concentration N-type impurity region disposed slightly apart to the right from the photoelectric conversion portion 3, a writing control gate WG which is a gate electrode disposed above the semiconductor substrate between the photoelectric conversion portion 3 and the writing drain WD with an oxide film 11 interposed therebetween, and a floating gate FG disposed between the writing control gate WG and the oxide film 11.

For example, polysilicon can be used as a conductive material of the writing control gate WG. Doped polysilicon doped with phosphorus (P), arsenic (As), and boron (B) at a high concentration may be used. Alternatively, silicide or salicide (self-aligned silicide) in which various metals such as titanium (Ti) or tungsten (W) are combined with silicon may be used.

The reading transistor RT has an MOS transistor structure including a reading drain RD which is a drain region formed of a high-concentration N-type impurity region disposed above the right side of the element separating region 5, a reading source RS which is a source region formed of an N-type impurity region disposed slightly apart to the right from the reading drain RD, a reading control gate RG which is a gate electrode disposed on the semiconductor substrate between the reading drain RD and the reading source RS with an oxide film 11 interposed therebetween, and a floating gate FG disposed between the reading control gate RG and the oxide film 11.

The same material as the writing control gate WG can be used as the conductive material of the reading control gate RG. A column signal line 12 is connected to the reading drain RD and a ground line is connected to the reading source RS. The impurity concentration of the reading drain RD is adjusted to form an ohmic contact with the column signal line 12. The impurity concentration of the reading source RS is adjusted to form an ohmic contact with the ground line.

The floating gate FG is an electrically floating electrode disposed above the semiconductor substrate between the P-type impurity layer 9 and the reading source RS with the oxide film 11 interposed therebetween. The writing control gate WG and the reading control gate RG are disposed above the floating gate FG with an insulating film 19 of silicon oxide or the like interposed therebetween. The same material as the writing control gate WG can be used as the conductive material of the floating gate FG.

The floating gate FG is not limited to a sheet lump common to the writing transistor WT and the reading transistor RT, but may have a structure in which the floating gates FG are individually provided to the writing transistor WT and the reading transistor RT and the separated two floating gates FG are electrically connected by a wire. The writing control gate WG and the photoelectric conversion portion 3 may partially overlap with each other so as to easily inject charges from the photoelectric conversion portion 3 to the floating gate FG.

The pixel unit 100 has a structure in which light is incident on only a part of the photoelectric conversion portion 3 by a light-blocking film not shown.

The solid-state imaging device 10 includes a control unit 40 controlling the writing transistor WT and the reading transistor RT, a reading circuit 20 detecting the threshold voltage of the reading transistor RT, a horizontal shift register 50 making a control of sequentially reading the threshold voltage of one line detected by the reading circuit 20 as the image capturing signal to the signal line 70, and an output amplifier 60 connected to the signal line 70.

The reading circuit 20 is provided to correspond to each column including plural pixel units 100 arranged in the column direction and is connected to the reading drains RD of the pixel units 100 in the corresponding column via the column signal line 12. The reading circuit 20 is also connected to the control unit 40.

As shown in FIG. 1B, the reading circuit 20 includes a reading controller 20a, a sense amplifier 20b, a pre-charge circuit 20c, a ramp-up circuit 20d, and transistors 20e and 20f.

At the time of reading a signal from the pixel units 100, the reading controller 20a supplies a drain voltage (Vr) from the pre-charge circuit 20c to the reading drains RD of the pixel unit 100 via the column signal line 12 by turning on the transistor 20f (pre-charge). Then, the reading controller 20a electrically connects the reading drains RD of the pixel units 100 to the sense amplifier 20b by turning on the transistor 20e.

The sense amplifier 20b monitors the voltage of the reading drains RD of the pixel units 100, detects the variation of the voltage, and notifies the ramp-up circuit 20d of the detection result. For example, the sense amplifier detects that the drain voltage pre-charged by the pre-charge circuit 20c is dropped and inverts the output of the sense amplifier.

The ramp-up circuit 20d has an N-bit counter built therein, supplies an increasing or decreasing ramp waveform voltage to the reading control gates RG of the pixel units 100 via the control unit 40, and outputs count values (N combinations of 1 and 0) corresponding to the value of the ramp waveform voltage.

When the voltage of the reading control gate RG is greater than the threshold voltage of the reading transistor RT, the reading transistor RT is turned on and the potential of the pre-charged column signal line 12 is dropped at this time. This voltage drop is detected by the sense amplifier 20b and an inverted signal is output. The ramp-up circuit 20d holds (latches) the count value corresponding to the value of the ramp waveform voltage at the time of receiving the inverted signal. Accordingly, the variation (image capturing signal) of the threshold voltage can be read as a digital value (a combination of 1 and 0).

When one horizontal selection transistor 30 is selected by the horizontal shift register 50, the count value held in the ramp-up circuit 20d connected to the horizontal selection transistor 30 is output to the signal line 70 and this value is output as an image capturing signal from the output amplifier 60.

The method of allowing the reading circuit 20 to read the variation in threshold voltage of the reading transistor RT is not limited to the above-mentioned method. For example, the drain current of the reading transistor RT may be read as the image capturing signal when a constant voltage is applied to the reading control gate RG and the reading drain RD.

The control unit 40 is connected to the writing control gates WG, the reading control gates RG, and the writing drains WD of the pixel units 100 in the lines including plural pixel units 100 arranged in the row direction via the writing control line, the reading control line, and the writing drain line. The impurity concentration of the writing drain WD is adjusted to form an ohmic contact with the writing drain line.

The control unit 40 controls the writing transistor WT to inject and accumulate the charges generated in the photoelectric conversion portion 3 in the floating gate FG. The method of injecting the charges into the floating gate FG may employ a hot electron injection method of injecting the charges into the floating gate FG using hot electrons such as channel hot electrons (CHE) or a tunnel electron injection method of injecting the charges into the floating gate FG by tunneling using the Fowler-Nordheim (F-N) tunnel current.

The control unit 40 controls the reading transistor RT by the above-mentioned method to read the image capturing signal corresponding to the charges accumulated in the floating gate FG.

The control unit 40 performs a first charge discharging drive operation of discharging the charges generated and accumulated in the photoelectric conversion portion 3 just before the start of an exposure period (a period when the photoelectric conversion portion 3 is exposed to acquire the image capturing signal for generating one piece of image data) of each pixel unit 100 to empty the photoelectric conversion portion 3 and a second charge discharging drive operation of discharging and erasing the charges accumulated in the floating gate FG.

The control unit 40 changes the details of the first charge discharging drive operation and the second charge discharging drive operation in the moving image capturing mode and the still image capturing mode.

The first charge discharging drive operation includes two types of a drain discharging drive operation of discharging the charges generated in the photoelectric conversion portion 3 just before the start of the exposure period to the writing drain WD or the reading drain RD just before the start of the exposure period and a substrate discharging drive operation of discharging the charges generated in the photoelectric conversion portion 3 to the semiconductor substrate.

A specific example of the drain discharging drive operation includes a method of discharging the charges generated in the photoelectric conversion portion 3 to the writing drain WD through the channel region of the writing transistor WT by applying a second voltage (Vcc), which is lower than a first voltage (Vpp) to be applied to the writing control gate WG to inject the charges into the floating gate FG by the writing transistor WT and which is a voltage such as not to cause the injection of the charges into the floating gate FG, to the writing control gate WG and a method of injecting the charges generated in the photoelectric conversion portion 3 to the floating gate FG by the writing transistor WT and discharging the charges injected into the floating gate FG to the reading drain RD.

The second charge discharging drive operation includes two types of a drain erasing drive operation of erasing the charges from the floating gate FG by applying a voltage (Vcc) having a first polarity (for example, positive polarity) to the writing drain WD and the reading drain RD and applying a voltage (−Vpp) having the opposite polarity (for example, negative polarity) of the first polarity to the writing control gate WG and the reading control gate RG so as to discharge the charges accumulated in the floating gate FG to the writing drain WD and the reading drain RD and a substrate erasing drive operation of erasing the charges by applying a positive voltage (Vcc) to the semiconductor substrate and applying a negative voltage (−Vpp) to the writing control gate WG and the reading control gate RG so as to pull out the charges accumulated in the floating gate FG to the semiconductor substrate.

The application of the voltage to the reading drain RD is carried out by controlling the reading controller 20a and the pre-charge circuit 20c. The pre-charge circuit 20c can generate two levels of voltage of a voltage (Vr) applied to the reading drain RD to read the image capturing signal and a voltage (Vcc) applied to the reading drain RD to erase the charges and supply the generated voltages to the column signal line 12, and supplies the voltage Vcc to the reading drain RD under the control of the control unit 40 at the time of erasing the charges. The reading controller 20a turns off the transistor 20e and turns on the transistor 20f under the control of the control unit 40 at the time of erasing the charges.

In FIG. 1A, the control unit 40 is built in the solid-state imaging device 10, but the function of the control unit 40 may be given to the imaging apparatus mounted with the solid-state imaging device 10.

The method of driving the solid-state imaging device having the above-mentioned configuration will be described now. Hereinafter, an example where the charges are injected by a CHE injection method will be described.

### Driving Method in Still Image Capturing Mode

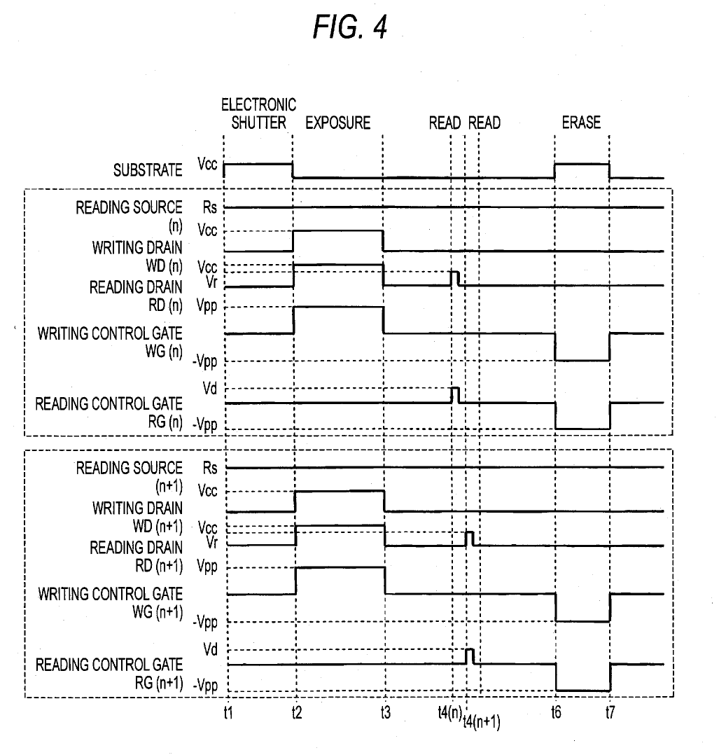

FIG. 4 is a timing diagram illustrating a driving method in the still image capturing mode in the solid-state imaging device shown in FIG. 1A. In FIG. 4, variations in potential of the portions of the pixel units 100 in the n-th line and variations in potential of the portions of the pixel units 100 in the (n+1)-th line are shown with the time. In FIG. 4, “(n)” or “(n+1)” added to the names of the elements of the solid-state imaging device indicates that the elements belong to the pixel units 100 in the n-th line or the (n+1)-th line. In the still image capturing mode, the imaging apparatus simultaneously exposes all the pixel units 100 of the solid-state imaging device 10 and captures an image.

First, at time t1 before the start of the exposure period, the control unit 40 sets the potential of the semiconductor substrate to Vcc as an electronic shutter operation and discharges the charges accumulated in the photoelectric conversion portions 3 of all the pixel units 100 before time t1 to the semiconductor substrate (substrate discharging drive). By this substrate discharging drive operation, the charges do not exist in the photoelectric conversion portions 3 of all the pixel units 100. Since the charges are erased from the floating gate FG before time t1, the charges are not accumulated in the floating gate FG at time t1. Therefore, the charges are not accumulated in the photoelectric conversion portions 3 and the floating gates FG of all the pixel units 100 by the discharging operation at time t1.

At time t2 which is the start time of the exposure period, the control unit 40 sets the potential of the semiconductor substrate to a low level. The control unit sets the potential of the writing control gates WG of all the pixel units 100 to Vpp, sets the potential of the writing drains WD to Vcc, and sets the potential of the reading drains RD to Vcc. By this voltage setting, the charges generated in the photoelectric conversion portions 3 during the exposure period are injected into the floating gates FG through the oxide film 11 (CHE injection).

To suppress the charges from leaking from the reading drains RD, the voltage of the reading drains RD of all the pixel units 100 may be set to the low level during the exposure period. Accordingly, it is possible to prevent the decrease in sensitivity.

When the injection of charges is carried out using the tunnel electron injection method, the potential of the writing drains WD during the exposure period can be set to the low level. When the drive operation of injecting the charges into the floating gates FG using the tunnel electron injection method is employed, it is possible to suppress the generation of dark current from the writing drains WD during the charge injection period into the floating gates FG, thereby providing a high-quality image with low noise.

In this way, the charges are simultaneously accumulated in all the pixel units 100 during the exposure period from time t2 to time t3. The thickness or the like of the oxide film 11 is adjusted to inject rapidly and satisfactorily the charges generated in the photoelectric conversion portions 3 into the floating gates FG.

At time t3 which is the end time of the exposure period, the control unit 40 sets the potentials of the writing control gates WG, the writing drains WD, and the reading drains RD of all the pixel units 100 to the low level. Accordingly, the charges generated in the photoelectric conversion portions 3 of all the pixel units 100 after time t3 are not injected into the floating gates FG and the accumulation of charges is thus ended.

At time t4(n) which is the start time of the reading period for reading the image capturing signal from the pixel units 100 in the n-th line, the control unit 40 pre-charges the reading drains RD of the pixel units 100 in the n-th line and starts applying a ramp waveform voltage to the reading control gates RG of the pixel units 100 in the n-th line (the waveform applied to the reading control gate RG is simplified in the drawing). The count value corresponding to the value of the ramp waveform voltage at the time when the potential of the reading drains RD in the n-th line is dropped is held in the reading circuits 20 and this count value is output as the image capturing signal from the output amplifier 60.

When the output of the image capturing signal from the pixel units 100 in the n-th line is ended (at time t4(n+1)), the control unit 40 pre-charges the reading drains RD of the pixel units 100 in the (n+1)-th line, starts the application of the ramp waveform voltage to the reading control gates RG of the pixel units 100 in the (n+1)-th line, and outputs the image capturing signal from the pixel units 100 in the (n+1)-th line.

In this way, the control unit 40 performs the drive operation of reading the image capturing signal at times different by (t4(n+1)−t4(n)) by the lines. Since the signal reading is carried out at every line, the reading wait period from time t3 to the start of the signal reading varies depending on the lines and is much greater than 1 msec in the longest line. Accordingly, the structure of the oxide film 11 is adjusted so as to prevent the charges from leaking in the exposure period and the reading wait period.

After sequentially reading the image capturing signals from all the pixel units 100, the control unit 40 sets the potentials of the writing control gates WG and the reading control gates RG of all the pixel units 100 to −Vpp and sets the potential of the semiconductor substrate to Vcc (time t6). Accordingly, the charges accumulated in the floating gates FG of all the pixel units 100 are discharged to the semiconductor substrate.

### Driving Method in Moving Image Capturing Mode

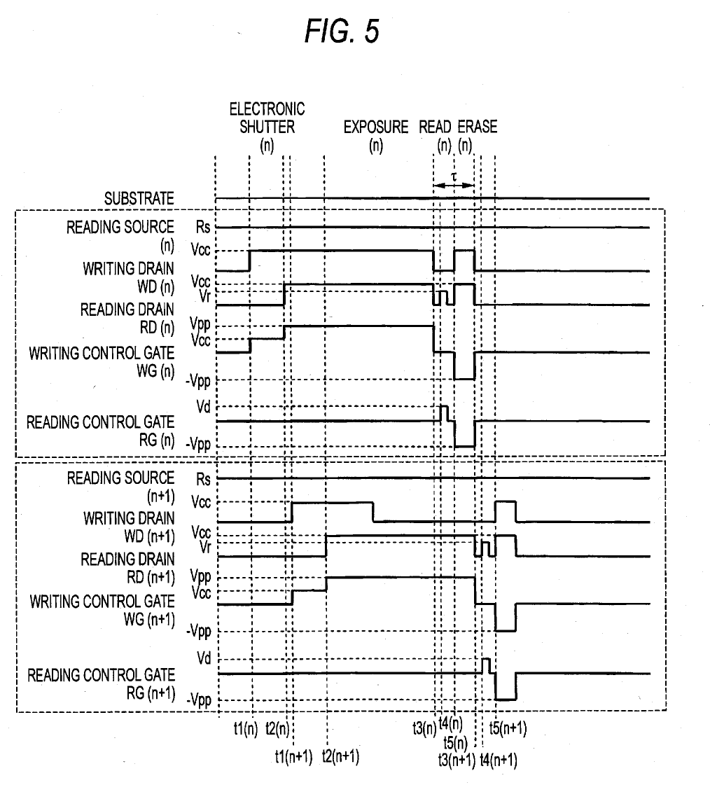

FIG. 5 is a timing diagram illustrating a driving method in the moving image capturing mode in the solid-state imaging device shown in FIG. 1A. In FIG. 5, variations in potential of the portions of the pixel units 100 in the n-th line and variations in potential of the portions of the pixel units 100 in the (n+1)-th line are shown with the time. In FIG. 5, “(n)” or “(n+1)” added to the names of the elements of the solid-state imaging device indicates that the elements belong to the pixel units 100 in the n-th line or the (n+1)-th line. In the moving image capturing mode, the imaging apparatus captures an image at different times by the lines of the solid-state imaging device 10.

At time t1(n) just before time t2(n) which is the start time of the exposure period of the pixel units 100 in the n-th line, the control unit 40 sets the potential of the writing drains WD and the writing control gates WG of the pixel units 100 in the n-th line to Vcc. Accordingly, the charges generated and accumulated in the photoelectric conversion portions 3 of the pixel units 100 in the n-th line before time t1(n) are not injected into the floating gates FG but moves to the writing drains WD through the channel regions of the writing transistors WT. Accordingly, the charges are not accumulated in the photoelectric conversion portions 3 of the pixel units 100 in the n-th line. Since the charges are erased from the floating gates FG before time t1(n), the charges are not also accumulated in the floating gates FG at time t1(n). Therefore, by the drain discharging operation at time t1(n), the charges are not accumulated in the photoelectric conversion portions 3 and the floating gates FG of the pixel units 100 in the n-th line.

At time t2(n), the control unit 40 sets the potential of the reading drains RD of the pixel units 100 in the n-th line to Vcc and sets the potential of the writing control gates WG to Vpp. By this voltage setting, the charges generated in the photoelectric conversion portions 3 during the exposure period are injected into the floating gates FG through the oxide film 11 (CHE injection).

To suppress the charges from leaking from the reading drains RD, the voltage of the reading drains RD of the pixel units 100 in the n-th line may be set to the low level during the exposure period. Accordingly, it is possible to prevent the decrease in sensitivity. When the charges are injected using the tunnel electron injection method, the potential of the writing drains WD can be set to the low level during the exposure period.

At time t3(n) which is end time of the exposure period of the pixel units 100 in the n-th line, the control unit 40 sets the potentials of the writing control gates WG, the writing drains WD, and the reading drains RD of the pixel units 100 in the n-th line to the low level. Accordingly, the charges generated in the photoelectric conversion portions 3 of the pixel units 100 in the n-th line after time t3(n) are not injected into the floating gates FG and the accumulation of the charges is ended.

At time t4(n) which is the start time of the reading period for reading the image capturing signal from the pixel units 100 in the n-th line, the control unit 40 pre-charges the reading drains RD of the pixel units 100 in the n-th line and starts applying a ramp waveform voltage to the reading control gates RG of the pixel units 100 in the n-th line. The count value corresponding to the value of the ramp waveform voltage at the time when the potential of the reading drains RD in the n-th line is dropped is held in the reading circuits 20 and this count value is output as the image capturing signal from the output amplifier 60.

After reading the image capturing signal from the pixel units 100 in the n-th line, the control unit 40 sets the potentials of the writing control gates WG and the reading control gates RG of the pixel units 100 in the n-th line to −Vpp and sets the potentials of the writing drains WD and the reading drains RD of the pixel units 100 in the n-th line to Vcc (at time t5(n)). At this time, the potential of the semiconductor substrate is not changed. Accordingly, the charges accumulated in the floating gates FG are all discharged to the writing drains WD and the reading drains RD. Since the writing drains WD and the reading drains RD are high-concentration impurity layers and have high potentials, the charges are satisfactorily discharged to the drains.

In this way, the control unit 40 reads the image capturing signal and erases the charges from the floating gates FG continuously after the end of the exposure period in the moving image capturing mode. When the time taken to read the image capturing signal of one line and to erase the charges is τ, the control unit 40 performs the drive operations at times t1(n) to t5(n) at times different by the time τ by the lines. The times obtained by adding τ to times t1(n) to t5(n) are t1(n+1) to t5(n+1). Since the exposure and the signal reading are carried out by the lines, the reading wait time is not necessary.

As described above, in the imaging apparatus mounted with the solid-state imaging device 10, the so-called rolling shutter driving operation is realized in the moving image capturing mode by discharging the charges from the photoelectric conversion portions 3 at different times by the lines using the drain discharging drive method and discharging the charges from the floating gates FG at different times by the lines using the drain erasing drive method. In the still image capturing mode, the so-called global shutter driving operation is realized by simultaneously discharging the charges from the photoelectric conversion portions 3 of all the pixel units 100 using the substrate discharging drive method and simultaneously discharging the charges from the floating gates FG of all the pixel units 100 using the substrate erasing drive method. In this way, since the drive methods suitable for the moving image capture and the still image capture are respectively employed, it is possible to allow the still image capture without any distortion to be consistent with the natural and smooth moving image capture.

Since the moving image capture and the still image capture can be realized optimally by just changing the drive method, it is possible to suppress the increase in manufacturing cost.

A modified example of the above-mentioned method of driving a solid-state imaging device will be described now.

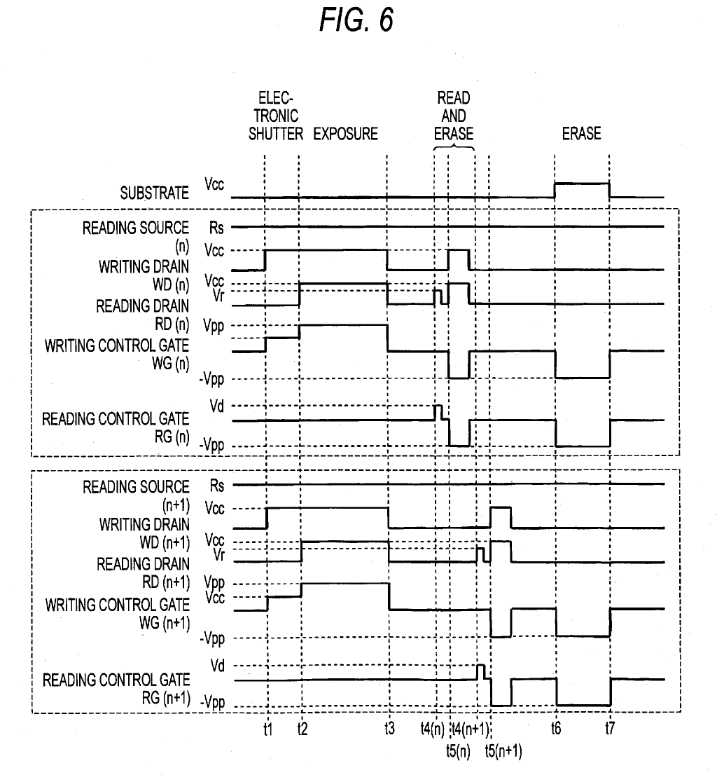

FIG. 6 is a timing diagram illustrating a modified example of the driving method in the still image capturing mode in the solid-state imaging device shown in FIG. 4. In FIG. 6, variations in potential of the portions of the pixel units 100 in the n-th line and variations in potential of the portions of the pixel units 100 in the (n+1)-th line are shown with the time. In FIG. 6, “(n)” or “(n+1)” added to the names of the elements of the solid-state imaging device indicates that the elements belong to the pixel units 100 in the n-th line or the (n+1)-th line.

In the driving method shown in FIG. 6, the substrate discharging drive method carried out between times t1 to t2 in FIG. 4 is replaced with the drain discharging drive method and the substrate erasing drive method carried out between times t6 and t7 in FIG. 4 is replaced with the drain erasing drive method by the lines.

First, at time t1, just before time t2 which is the start time of the exposure period of all the pixel units 100, the control unit 40 sets the potentials of the writing drains WD and the writing control gates WG of all the pixel units 100 to Vcc.

Accordingly, the charges generated and accumulated in the photoelectric conversion portions 3 before time t1 are not injected into the floating gates FG but move to the writing drains WD through the channel regions of the writing transistors WT. The charges are not accumulated in the photoelectric conversion portions 3 of all the pixel units 100. Since the charges are erased from the floating gates FG before time t1, the charges are not accumulated in the floating gates FG at time t1. Therefore, by the discharging operation at time t1, the charges are not accumulated in the photoelectric conversion portions 3 and the floating gates FG.

The drive operations from time t2 which is the start time of the exposure period to time t4(n) which is the start time of signal reading are the same as shown in FIG. 4.

At time t4(n) which is the start time of the reading period for reading the image capturing signal from the pixel units 100 in the n-th line, the control unit 40 pre-charges the reading drains RD of the pixel units 100 in the n-th line and starts applying a ramp waveform voltage to the reading control gates RG of the pixel units 100 in the n-th line. The count value corresponding to the value of the ramp waveform voltage at the time when the potential of the reading drains RD in the n-th line is dropped is held in the reading circuits 20 and this count value is output as the image capturing signal from the output amplifier 60.

After reading the image capturing signal from the pixel units 100 in the n-th line, the control unit 40 sets the potentials of the writing control gates WG and the reading control gates RG of the pixel units 100 in the n-th line to −Vpp and sets the potentials of the writing drains WD and the reading drains RD of the pixel units 100 in the n-th line to Vcc (at time t5(n)). At this time, the potential of the semiconductor substrate is not changed. Accordingly, the charges accumulated in the floating gates FG are all discharged to the writing drains WD and the reading drains RD. Since the writing drains WD and the reading drains RD are high-concentration impurity layers and have high potentials, the charges are satisfactorily discharged to the drains.

After the reading of the image capturing signal and the erasing of the charges from the pixel units 100 in the n-th line are finished, the control unit 40 pre-charges the reading drains RD of the pixel units 100 in the (n+1)-th line at time t4(n+1), starts applying the ramp waveform voltage to the reading control gates RG of the pixel units 100 in the (n+1)-th line, and outputs the image capturing signals from the pixel units 100 in the (n+1)-th line. After outputting the image capturing signals, the control unit sets the potentials of the writing control gates WG and the reading control gates RG of the pixel units 100 in the (n+1)-th line to Vpp and sets the potentials of the writing drains WD and the reading drains RD of the pixel units 100 in the (n+1)-th line to Vcc, thereby erasing the charges from the floating gates FG (time t5(n+1)).

In this way, the control unit 40 performs the reading of the image capturing signals and the erasing of the charges at times different by (t4(n+1)−t4(n)) by the lines. Since the signals are read by the lines, the reading wait time from time t3 to the start of the signal reading varies depending on the lines and is much greater than 1 msec in the longest line. Accordingly, the structure of the oxide film 11 is adjusted so as to prevent the charges from leaking in the exposure period and the reading wait period.

As described above, by employing the driving method shown in FIG. 6 in the still image capturing mode, it is not necessary to change the potential of the semiconductor substrate in any of the still image capturing mode and the moving image capturing mode. Accordingly, it is possible to prevent the deterioration of the oxide film 11 due to the potential variation of the semiconductor substrate or the increase in dark current in the vicinity of the source and drain junctions of the writing transistors WT and the reading transistors RT.

In the driving methods shown in FIGS. 4 to 6, the exposure and the injection of the charges generated in the photoelectric conversion portions 3 at the time of exposure into the floating gates FG are simultaneously carried out. However, the exposure and the injection of the charges may be carried out separately without overlapping with each other. The method of driving the solid-state imaging device when the exposure and the injection of the charges are separately carried out will be described now.

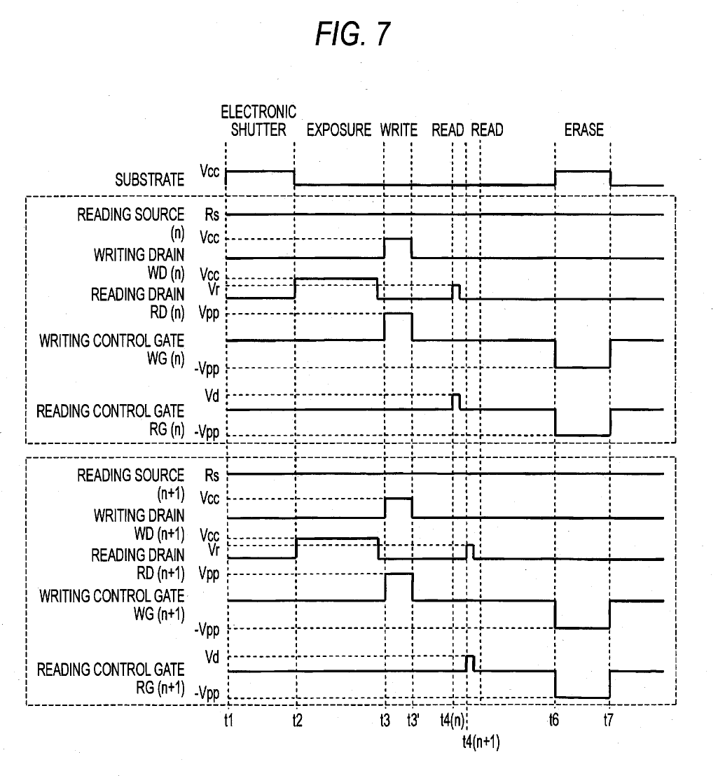

FIG. 7 is a timing diagram illustrating a modified example of the driving method in the still image capturing mode shown in FIG. 4. In FIG. 7, variations in potential of the portions of the pixel units 100 in the n-th line and variations in potential of the portions of the pixel units 100 in the (n+1)-th line are shown with the time. In FIG. 7, “(n)” or “(n+1)” added to the names of the elements of the solid-state imaging device indicates that the elements belong to the pixel units 100 in the n-th line or the (n+1)-th line.

While the driving method shown in FIG. 4 includes simultaneously carrying out the exposure and the injection of the charges into the floating gates FG, the driving method shown in FIG. 7 includes separately carrying out the exposure and the injection of the charges into the floating gates FG.

The drive operations of times t1 to t2 are the same as shown in FIG. 4.

At time t2 which is the start time of the exposure period based on the image capture conditions, the control unit 40 sets the potential of the semiconductor substrate to the low level and sets the potentials of the reading drains RD of all the pixel units 100 to Vcc. At this time, the potentials of the writing control gates WG and the writing drains WD of all the pixel units 100 are set to the low level, whereby the charges generated in the photoelectric conversion portions 3 are not injected into the floating gates FG by the writing transistors WT. By this voltage setting, the charges generated in the photoelectric conversion portions 3 of all the pixel units 100 during the exposure period are accumulated in the photoelectric conversion portions 3. Since the potential of the writing drains WD is set to the low level, the dark current generated in the writing drains WD decreases. Since the potential of the writing control gates WG is set to the low level, the dark current is not injected into the floating gates FG and any noise is not mixed into the floating gates FG. During the exposure period, the potentials of the reading drains RD may be set to the low level.

At time t3 which is the end time of the exposure period (the start time of the writing period), the control unit 40 sets the potential of the writing control gates WG of all the pixel units 100 to Vpp and sets the potential of the writing drains WD to Vcc. By this voltage setting, the charges accumulated in the photoelectric conversion portions 3 during the exposure period are injected into the floating gates FG through the oxide film 11 (CHE injection). The control unit 40 sets the voltage of the reading drains RD of all the pixel units 100 to the low level so as to suppress the charges from leaking from the reading drains RD during the writing period. Accordingly, it is possible to prevent the decrease in sensitivity.

In the writing period from time t3 to time t3′, there is a risk that noise resulting from the dark current from the writing drains WD may be injected into the floating gates FG. However, since the writing period is much shorter than the exposure period, the noise resulting from the dark current generated in this period can be negligibly low. When the charges are injected into the floating gates FG using the tunnel electron injection method by setting the potential of the writing drains WD in the writing period to the low level, it is possible to further reduce the noise.

In this way, the charges are simultaneously accumulated in all the pixel units 100 during the exposure period from time t2 to time t3. During the writing period from time t3 to time t3′, the charges are simultaneously injected into the floating gates FG of all the pixel units 100. The thickness or the like of the oxide film 11 is adjusted to inject rapidly and satisfactorily the charges accumulated in the photoelectric conversion portions 3 into the floating gates FG.

At the end time of the writing period (time t3′), the control unit 40 sets the potentials of the writing control gates WG and the writing drains WD of all the pixel units 100 to the low level. Accordingly, the charges generated in the photoelectric conversion portions 3 of all the pixel units 100 after time t4 are not injected into the floating gates FG and the writing of charges is ended. The drive operation after the end of the writing period is the same as the drive operation after the end of the exposure period shown in FIG. 4.

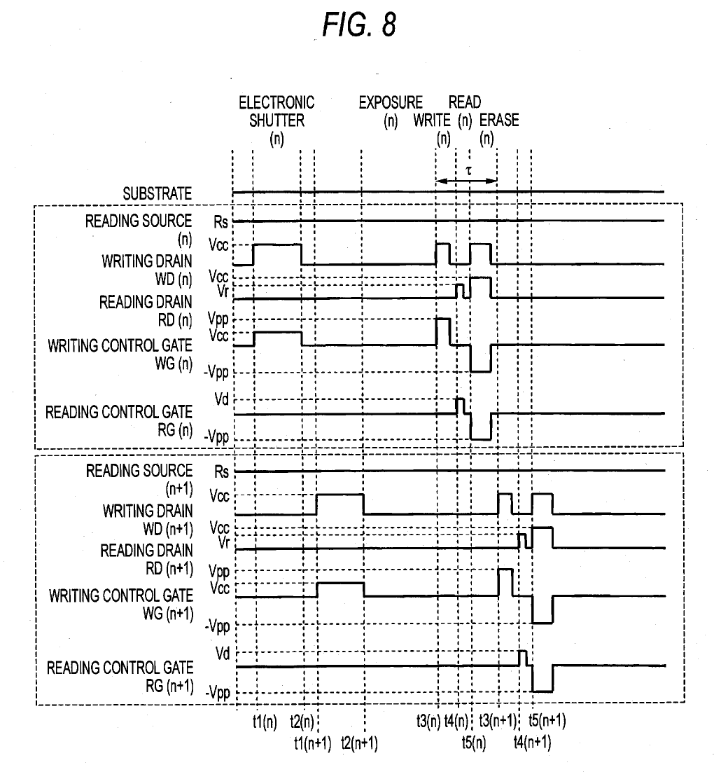

FIG. 8 is a timing diagram illustrating a modified example of the driving method in the moving image capturing mode shown in FIG. 5. In FIG. 8, variations in potential of the portions of the pixel units 100 in the n-th line and variations in potential of the portions of the pixel units 100 in the (n+1)-th line are shown with the time. In FIG. 8, “(n)” or “(n+1)” added to the names of the elements of the solid-state imaging device indicates that the elements belong to the pixel units 100 in the n-th line or the (n+1)-th line.

While the driving method shown in FIG. 5 includes simultaneously carrying out the exposure and the injection of the charges into the floating gates FG on every line, the driving method shown in FIG. 8 includes separately carrying out the exposure and the injection of the charges into the floating gates FG.

At time t1(n) just before time t2(n) which is the start time of the exposure period of the pixel units 100 in the n-th line, the control unit 40 sets the potentials of the writing drains WD and the writing control gates WG of the pixel units 100 in the n-th line to Vcc. Accordingly, the charges generated and accumulated in the photoelectric conversion portions 3 of the pixel units 10 in the n-th line before time t1(n) are not injected into the floating gates FG but move to the writing drains WD through the channel regions of the writing transistors WT. Accordingly, the charges are not accumulated in the photoelectric conversion portions 3 of the pixel units 100 in the n-th line. Since the charges are erased from the floating gates FG before time t1(n), the charges are not also accumulated in the floating gates FG at time t1(n). Therefore, by the drain discharging operation at time t1(n), the charges are not accumulated in the photoelectric conversion portions 3 and the floating gates FG of the pixel units 100 in the n-th line.

At time t2(n), the control unit 40 sets the potentials of the writing control gates WG and the writing drains WD to the low level, whereby the charges generated in the photoelectric conversion portions 3 are not injected into the floating gates FG by the writing transistors WT. By this voltage setting, the charges generated in the photoelectric conversion portions 3 of all the pixel units 100 during the exposure period are accumulated in the photoelectric conversion portions 3. Since the potential of the writing drains WD is set to the low level, the dark current generated in the writing drains WD decreases. Since the potential of the writing control gates WG is set to the low level, the dark current is not injected into the floating gates FG and any noise is not mixed into the floating gates FG.

At time t3(n) which is the end time of the exposure period (the start time of the writing period) of the pixel units 100 in the n-th line, the control unit 40 sets the potential of the writing control gates WG of the pixel units 100 in the n-th line to Vpp and sets the potential of the writing drains WD to Vcc. By this voltage setting, the charges accumulated in the photoelectric conversion portions 3 during the exposure period are injected into the floating gates FG through the oxide film 11 (CHE injection). The control unit 40 sets the voltage of the reading drains RD of the pixel units 100 in the n-th line to the low level so as to suppress the charges from leaking from the reading drains RD during the writing period. Accordingly, it is possible to prevent the decrease in sensitivity. During the writing period, the potential of the writing drains WD may be set to the low level and the charges may be injected into the floating gates FG using the tunnel electron injection method.

At the end time of the writing period in the pixel units 100 in the n-th line, the control unit 40 sets the potentials of the writing control gates WG and the writing drains WD of the pixel units 100 in the n-th line to the low level. Accordingly, the charges generated in the photoelectric conversion portions 3 of the pixel units 100 in the n-th line after the end of the writing period are not injected into the floating gates FG and the writing of the charges is ended. The drive operation after the end of the writing period is the same as the drive operation after the end of the exposure period shown in FIG. 5.

In this way, the control unit 40 writes the charges, reads the image capturing signal, and erases the charges from the floating gates FG continuously after the end of the exposure period in the moving image capturing mode. When the time taken to write the charges of one line, to read the image capturing signal, and to erase the charges is τ, the control unit 40 performs the drive operations at times t1(n) to t5(n) at times different by the time τ by the lines in the moving image capturing mode. The times are obtained by adding τ to times t1(n) to t5(n) are t1(n+1) to t5(n+1).

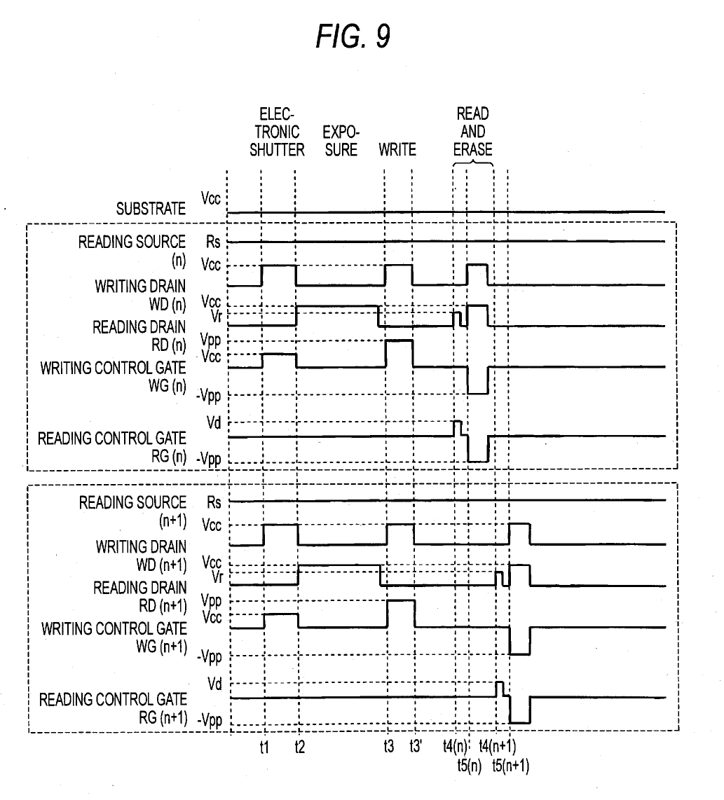

FIG. 9 is a timing diagram illustrating a modified example of the driving method in the still image capturing mode shown in FIG. 6. In FIG. 9, variations in potential of the portions of the pixel units 100 in the n-th line and variations in potential of the portions of the pixel units 100 in the (n+1)-th line are shown with the time. In FIG. 9, “(n)” or “(n+1)” added to the names of the elements of the solid-state imaging device indicates that the elements belong to the pixel units 100 in the n-th line or the (n+1)-th line.

While the driving method shown in FIG. 6 includes simultaneously carrying out the exposure and the injection of the charges into the floating gates FG, the driving method shown in FIG. 9 includes separately carrying out the exposure and the injection of the charges into the floating gates FG.

The drive operations just before time t2 are the same as shown in FIG. 6.

At time t2 which is the start time of the exposure period based on the image capture conditions, the control unit 40 sets the potentials of the writing control gates WG and the writing drains WD of all the pixel units 100 to the low level, whereby the charges generated in the photoelectric conversion portions 3 are not injected into the floating gates FG by the writing transistors WT. By this voltage setting, the charges generated in the photoelectric conversion portions 3 of all the pixel units 100 during the exposure period are accumulated in the photoelectric conversion portions 3. Since the potential of the writing drains WD is set to the low level, the dark current generated in the writing drains WD decreases. Since the potential of the writing control gates WG is set to the low level, the dark current is not injected into the floating gates FG and any noise is not mixed into the floating gates FG. During the exposure period, the potential of the reading drains RD may be set to Vcc or the low level.

At time t3 which is the end time of the exposure period (the start time of the writing period), the control unit 40 sets the potential of the writing control gates WG of all the pixel units 100 to Vpp and sets the potential of the writing drains WD to Vcc. By this voltage setting, the charges accumulated in the photoelectric conversion portions 3 during the exposure period are injected into the floating gates FG through the oxide film 11 (CHE injection). The control unit 40 sets the voltage of the reading drains RD of all the pixel units 100 to the low level so as to suppress the charges from leaking from the reading drains RD during the writing period. Accordingly, it is possible to prevent the decrease in sensitivity. During the writing period, the potential of the writing drains WD may be set to the low level and the charges may be injected into the floating gates FG using the tunnel electron injection method.

At the end time of the writing period (time t3′), the control unit 40 sets the potentials of the writing control gates WG and the writing drains WD of all the pixel units 100 to the low level. Accordingly, the charges generated in the photoelectric conversion portions 3 of all the pixel units 100 after time t3′ are not injected into the floating gates FG and the writing of charges is ended. The drive operation after the end of the writing period is the same as the drive operation after the end of the exposure period shown in FIG. 6.

In the driving methods shown in FIGS. 7 to 9, since the charges are not injected into the floating gates FG during the exposure period, it is possible to lower the possibility that the noise generated during the exposure period is mixed into the floating gates FG. The injection of the charges generated during the exposure period into the floating gates FG can be carried out for a time much shorter than the exposure period. Accordingly, the mixture of the noise into the floating gates FG during the period (writing period) when the charges are injected can be reduced to a negligible extent. As a result, it is possible to capture a high-quality image with reduced noise.

In the above description, the method of discharging the charges generated in the photoelectric conversion portions 3 to the writing drains WD through the channel regions of the writing transistors WT is employed as the drain discharging drive method, but a method of discharging the charges generated in the photoelectric conversion portions 3 to the reading drains RD through the floating gates FG may be employed.

In this case, in order to erase the charges from the photoelectric conversion portions 3, the control unit 40 can inject the charges in the photoelectric conversion portions 3 into the floating gates FG by setting the potential of the writing drains WD to Vcc or the low level and setting the potential of the writing control gates WG to Vpp, and can instantaneously discharge the charges injected into the floating gates FG to the reading drains RD by setting the potentials of the reading control gates RD to −Vpp and setting the potential of the reading drains RD to Vcc.

In the above description, the charges accumulated in the floating gates FG are discharged to the writing drains WD and the reading drains RD at the time of the drain erasing drive, but the discharge destination of the charges may be one thereof. That is, at the time of erasing the charges in FIGS. 5, 6, 8, and 9, a drive method of setting the potentials of the writing drains WD or the reading drains RD to the low level may be employed.

In the above description, each pixel unit 100 includes two transistors of the writing transistor WT and the reading transistor RT, but the functions of the writing transistor WT and the reading transistor RT may be performed by one transistor.

For example, in FIG. 2, the reading transistor RT may be omitted and the writing drain WD may be connected to the reading circuit 20 via the column signal line 12. In this configuration, it is possible to read the image capturing signals by setting the potential of the writing drain WD to Vr during the signal reading period and applying the ramp waveform voltage to the writing control gate WG, for example, in the driving methods shown in FIGS. 4 to 9.

When the accumulating of the charges, the reading of the signals, and the erasing of the charges are carried out using one transistor, the charge discharging passage at the time of erasing the charges includes only the writing drains WD. On the contrary, in the configuration shown in FIG. 2, the charge discharging passage at the time erasing the charges includes both of the writing drains WD and the reading drains RD. Accordingly, it is possible to smoothly discharge the charges and to reduce the charge discharging time or satisfactorily prevent the charges from remaining in the floating gate FG, thereby improving the charge discharging efficiency at the time of performing the drain erasing drive operation. As a result, it is possible to capture a high-quality image with a suppressed afterimage.

As described above, when the reading portion is embodied by one transistor, a structure other than the MOS structure may be employed by the transistor. For example, an MNOS transistor structure in which the floating gate FG shown in FIG. 2 is formed of a nitride film and the writing control gate WG is formed directly on the nitride film and an MONOS structure in which the floating gate FG shown in FIG. 2 is formed of a nitride film may be employed. A trap level of the film including the nitride film and the oxide film 11 serves as the charge accumulating portion for accumulating the charges in the MNOS and the nitride film serves as the charge accumulating portion for accumulating the charges in the MONOS.

In the above description, the photoelectric conversion portion 3 is formed in the semiconductor substrate, but the invention is not limited to this configuration.

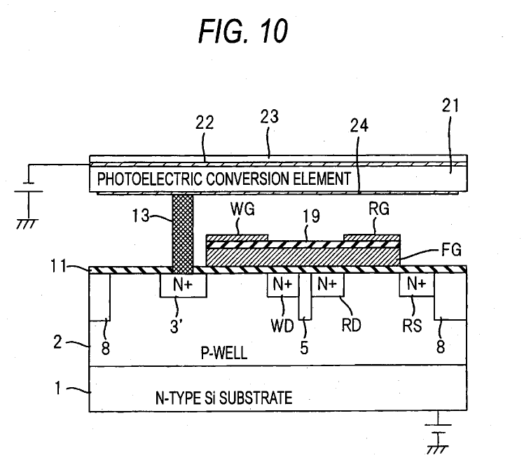

FIG. 10 is a sectional view schematically illustrating another configuration of the pixel unit of the solid-state imaging device shown in FIG. 1A. In the pixel unit shown in FIG. 10, an N-type impurity layer 3′ is disposed instead of the P-type impurity layer 9 and the photoelectric conversion portion 3 of the pixel unit shown in FIG. 2. The N-type impurity layer 3′ serves as a source region of the writing transistor WT.

Pixel electrodes 24 separating every pixel unit are formed on the semiconductor substrate. A photoelectric conversion film 21 is formed on the pixel electrodes 24 and a counter electrode 22 is formed on the photoelectric conversion film 21. A passivation film 23 transmitting incident light is formed on the counter electrode 22.

The counter electrode 22 is formed of a conductive material (for example, a metal compound such as ITO or a very thin metal film) transmitting the incident light and is common to all the pixel units. The photoelectric conversion film 21 is a film formed of an organic or inorganic photoelectric conversion material generating charges depending on the incident light and is common to all the pixel units. The photoelectric conversion film 21 can be formed of, for example, an amorphous silicon or a CIGS (Copper-Indium-Gallium-Selenium)-based material.

The counter electrode 22 and the photoelectric conversion film 21 may separate every pixel unit 100. The counter electrode 22 may have a structure in which rectangular electrodes are wired in common.

The N-type impurity layer 3′ is connected to the pixel electrode 24 via a plug 13 formed of a conductive material such as aluminum and is thus electrically connected to the photoelectric conversion film 21.

In the solid-state imaging device having the above-mentioned structure, when the exposure period is started, the charges generated in the photoelectric conversion film 21 during the exposure period move to the N-type impurity layer 3′ via the pixel electrode 24 and the plug 13. Then, the charges moving to the N-type impurity layer 3′ are injected into the floating gate FG through the oxide film 11.

Accordingly, even the solid-state imaging device having the structure in which the photoelectric conversion portion is disposed on the semiconductor substrate can exhibit the same advantages as described above. In the configuration shown in FIG. 10, since the photoelectric conversion portion is disposed above the reading portion, the opening can be taken wide, thereby improving the sensitivity. Therefore, it is possible to provide a high-quality image particularly at a low intensity of illumination.

In the above description, it is assumed that the charges to be treated (charges taken out as the image capturing signal) are electrons, but the same idea is applied to the case when the charges to be treated are holes. When the charges to be treated are holes, the N regions and the P regions in the drawing may be exchanged and the polarities of the voltages applied to the portions may be inverted.

What is claimed is:

1. An imaging apparatus comprising:
pixel groups;
wherein each pixel group includes plural pixel units,
each pixel unit includes
a photoelectric conversion portion, and
a transistor having a charge accumulating portion which is disposed above a semiconductor substrate and which accumulates electric charges generated in the photoelectric conversion portion, and
an exposure start control unit that independently performs, for each pixel group, a first charge discharging drive operation of discharging the electric charges generated in the photoelectric conversion portions of the pixel units to drain regions of the transistors of the pixel units, to control an exposure period start timing of each pixel group.

2. The imaging apparatus according to claim 1, further comprising;
a charge discharging unit for performing a second charge discharging drive operation of (I) reading a signal corresponding to the electric charges generated in the photoelectric conversion portions of the pixel units of each pixel group during an exposure period of each pixel group and accumulated in the charge accumulating portion of each pixel unit, and (II) discharging the electric charges to the drain regions of the transistors of the pixel units of each pixel group,
wherein first timings of the respective pixel groups at which the charge discharging unit performs the second charge discharging drive operation for the pixel groups are different from each other.

3. The imaging apparatus according to claim 2, further comprising:
a simultaneous exposure start control unit that simultaneously discharges the electric charges generated in the photoelectric conversion portions of the pixel units of all the pixel groups to the semiconductor substrate to match start timings of the exposure periods of all the pixel units with each other in a still image capturing mode; and
a simultaneous charge discharging unit that simultaneously discharges the electric charges accumulated in the charge accumulating portions of the pixel units of all the pixel groups to the semiconductor substrate in the still image capturing mode,
wherein the exposure start control unit and the charge discharging unit operate only in a moving image capturing mode,
the exposure start control unit performs the first charge discharging drive operation for the pixel groups, and
second timings of the respective pixel groups at which the exposure start control unit performs the first charge discharging drive operation for the pixel groups are different from each other.

4. The imaging apparatus according to claim 2,
wherein the exposure start control unit simultaneously performs the first charge discharging drive operation for all the pixel groups in a still image capturing mode,
second timings of the respective pixel groups at which the exposure start control unit performs the first charge discharging drive operation for the pixel groups are different from each other in a moving image capturing mode, and
the charge discharging unit performs the second charge discharging drive operation in the still image capturing mode and the moving image capturing mode.

5. The imaging apparatus according to claim 1,
wherein the transistor of each pixel unit is a writing transistor for injecting and accumulating the electric charges in the charge accumulating portion of each pixel unit, and
the first charge discharging drive operation is a drive operation of discharging the electric charges generated in the photoelectric conversion portions of each pixel group to the drain regions of the writing transistors of each pixel group through channel regions of the writing transistors of each pixel group by applying to gate electrodes of the writing transistors of each pixel group a second voltage lower than a first voltage to be applied to the gate electrodes of the writing transistors of each pixel group to inject the electric charges into the charge accumulating portions of each pixel group by means of the writing transistors of each pixel group.

6. The imaging apparatus according to claim 1,
wherein each pixel unit further includes another transistor,
the two transistors of each pixel unit include a writing transistor for injecting and accumulating the electric charges in the charge accumulating portion of each pixel unit and a reading transistor for reading a signal corresponding to the electric charges accumulated in the charge accumulating portion of each pixel unit,
a floating gate of the writing transistor and a floating gate of the reading transistor are electrically connected to each other,
the charge accumulating portion of each pixel unit includes the floating gates, and
the first charge discharging drive operation is a drive operation of injecting the electric charges generated in the photoelectric conversion portions of each pixel group into the floating gates of the writing transistors of each pixel group and discharging the electric charges injected into the floating gates of each pixel group to the drain regions of the reading transistors of each pixel group.

7. The imaging apparatus according to claim 5, further comprising:
a driving unit that drives the writing transistor of each pixel unit to inject the electric charges, which are generated in the photoelectric conversion portion of each pixel unit during the exposure period, into the charge accumulating portion of each pixel unit during the exposure period.

8. The imaging apparatus according to claim 5, further comprising:
a driving unit that drives the writing transistors to stop, during the exposure period, injecting the electric charges, which are generated in the photoelectric conversion portions, into the charge accumulating portions, and drives the writing transistors to inject the electric charges, which are generated in the photoelectric conversion portions during the exposure period, into the charge accumulating portions after an end of the exposure period.

9. The imaging apparatus according to claim 1,
wherein each photoelectric conversion portion includes a photoelectric conversion element disposed above the semiconductor substrate.

10. The imaging apparatus according to claim 9,
wherein each photoelectric conversion element is formed of one of an amorphous silicon, a CIGS (Copper-Indium-gallium-selenium)-based material, and an organic material.

11. A method of driving a solid-state imaging device including pixel groups,
wherein each pixel group includes plural pixel units,
each pixel unit includes
a photoelectric conversion portion, and
a transistor having a charge accumulating portion which is disposed above a semiconductor substrate and which accumulates electric charges generated in the photoelectric conversion portion,
the method comprising:
an exposure start control step of independently performing, for each pixel group, a first charge discharging drive operation of discharging the electric charges generated in the photoelectric conversion portions of the pixel units to drain regions of the transistors of the pixel units, to control an exposure period start timing of each pixel group.

12. The method of driving the solid-state imaging device according to claim 11, further comprising;
a charge discharging step of performing a second charge discharging drive operation of (I) reading a signal corresponding to the electric charges generated in the photoelectric conversion portions of the pixel units of each pixel group during an exposure period of each pixel group and accumulated in the charge accumulating portion of each pixel unit, and (II) discharging the electric charges to the drain regions of the transistors of the pixel units of each pixel group,
wherein first timings of the respective pixel groups at which the charge discharging step performs the second charge discharging drive operation for the pixel groups are different from each other.

13. The method of driving the solid-state imaging device according to claim 12, further comprising:
a simultaneous exposure start control step of simultaneously discharging the electric charges generated in the photoelectric conversion portions of the pixel units of all the pixel groups to the semiconductor substrate to match start timings of the exposure periods of all the pixel units with each other in a still image capturing mode; and
a simultaneous charge discharging step of simultaneously discharging the electric charges accumulated in the charge accumulating portions of the pixel units of all the pixel groups to the semiconductor substrate in the still image capturing mode,
wherein the exposure start control step and the charge discharging step are performed only in a moving image capturing mode,
the exposure start control step performs the first charge discharging drive operation for the pixel groups, and
second timings of the respective pixel groups at which the exposure start control step performs the first charge discharging drive operation for the pixel groups are different from each other.

14. The method of driving the solid-state imaging device according to claim 12,
wherein the exposure start control step simultaneously performs the first charge discharging drive operation for all the pixel groups in a still image capturing mode,
second timings of the respective pixel groups at which the exposure start control step performs the first charge discharging drive operation for the pixel groups are different from each other in a moving image capturing mode, and
the charge discharging step performs the second charge discharging drive operation in the still image capturing mode and the moving image capturing mode.

15. The method of driving the solid-state imaging device according to claim 11,
wherein the transistor of each pixel unit is a writing transistor for injecting and accumulating the electric charges in the charge accumulating portion of each pixel unit, and
the first charge discharging drive operation is a drive operation of discharging the electric charges generated in the photoelectric conversion portions of each pixel group to the drain regions of the writing transistors of each pixel group through channel regions of the writing transistors of each pixel group by applying to gate electrodes of the writing transistors of each pixel group a second voltage lower than a first voltage to be applied to the gate electrodes of the writing transistors of each pixel group to inject the electric charges into the charge accumulating portions of each pixel group by means of the writing transistors of each pixel group.

16. The method of driving the solid-state imaging device according to claim 11,
wherein each pixel unit further includes another transistor,
the two transistors of each pixel unit include a writing transistor for injecting and accumulating the electric charges in the charge accumulating portion of each pixel unit and a reading transistor for reading a signal corresponding to the electric charges accumulated in the charge accumulating portion of each pixel unit,
a floating gate of the writing transistor and a floating gate of the reading transistor are electrically connected to each other,
the charge accumulating portion of each pixel unit includes the floating gates, and
the first charge discharging drive operation is a drive operation of injecting the electric charges generated in the photoelectric conversion portions of each pixel group into the floating gates of the writing transistors of each pixel group and discharging the electric charges injected into the floating gates of each pixel group to the drain regions of the reading transistors of each pixel group.

17. The method of driving the solid-state imaging device according to claim 15, further comprising:
a driving step of driving the writing transistor of each pixel unit to inject the electric charges, which are generated in the photoelectric conversion portion of each pixel unit during the exposure period, into the charge accumulating portion of each pixel unit during the exposure period.

18. The method of driving the solid-state imaging device according to claim 15, further comprising:
a driving step of driving the writing transistors to stop, during the exposure period, injection the electric charges, which are generated in the photoelectric conversion portions, into the charge accumulating portions, and driving the writing transistors to inject the electric charges, which are generated in the photoelectric conversion portions during the exposure period, into the charge accumulating portions after an end of the exposure period.

19. The method of driving the solid-state imaging device according to claim 11,
wherein each photoelectric conversion portion includes a photoelectric conversion element disposed above the semiconductor substrate.

20. The method of driving the solid-state imaging device according to claim 19,
wherein each photoelectric conversion element is formed of one of an amorphous silicon, a CIGS (Copper-Indium-gallium-selenium)-based material, and an organic material.
